(19) United States
(12) Patent Application Publication
(10) Pub. No.: US 2025/0157063 A1
(43) Pub. Date: May 15, 2025

(54) INFORMATION PROCESSING DEVICE FOR ACQUIRING DEPTH INFORMATION OF IMAGE, AND INFORMATION PROCESSING METHOD

(71) Applicant: CANON KABUSHIKI KAISHA, Tokyo (JP)

(72) Inventor: TETSUHIKO YAO, Tokyo (JP)

(21) Appl. No.: 18/932,996

(22) Filed: Oct. 31, 2024

(30) Foreign Application Priority Data
Nov. 13, 2023 (JP) 2023-192821

(51) Int. Cl. G06T 7/50

(52) U.S. Cl. CPC G06T 7/50

(57) ABSTRACT

An information processing device acquires first depth information, which is depth information of a first image in which a plurality of virtual objects including a translucent material are disposed, and generates the first image on the basis of the first depth information. The information processing device acquires second depth information indicating a depth of the translucent material in the first image. The information processing device corrects the first depth information on the basis of the second depth information.

### BACKGROUND OF THE INVENTION

### Field of the Invention

The present invention relates to an information processing device, and an information processing method.

### Description of the Related Art

In a metaverse, in some cases a user creates an avatar, which is an alter ego of himself/herself, and performs exchange and shopping in a virtual space. In the metaverse, in order to implement expressions with more originalities, there is a need that a translucent material (translucent virtual object) is desirably used.

On the other hand, a problem may arise when drawing a translucent material. In general CG rendering processing, in order to efficiently draw a large number of materials (virtual objects), drawing processing of a material, which is present at a position deeper than a position indicated by the depth information, is omitted by managing the depth information of a frontmost surface of each pixel.

However, since the translucent material has permeability, a material, which is present at a position deeper than the translucent material, also needs to be drawn. Thus, a depth of the translucent material is not reflected in the depth information acquired at the rendering processing. Moreover, in an HMD, which is a device for experiencing the metaverse, there are a plurality of types of image processing using the depth of a CG image. If accurate depth information cannot be used, a quality of results of these types of image processing deteriorates, and there is a possibility that the user's experience is impaired.

In Japanese Patent Application Publication No. 2008-310377, a threshold value is provided in order to determine a translucent material, and a material with transparency equal to or lower than the threshold value is handled as an opaque material, while a material with the transparency higher than the threshold value is handled as a translucent material. In this case, a virtual object, which is present at a position deeper than the material with transparency equal to or lower than the threshold value, cannot be drawn. On the other hand, the depth of the material with permeability equal to or smaller than the threshold value can be acquired.

In Japanese Patent Application Publication No. 2008-310377, a threshold value is provided for permeability, and a material with transparency equal to or lower than the threshold value is handled as an opaque material. As a result, the material with transparency equal to or lower than the threshold value can be handled as a material whose depth can be acquired. However, the depth of the material with permeability higher than the threshold value cannot be reflected in the depth information of a CG image.

### SUMMARY OF THE INVENTION

Thus, the present invention has an object to provide an art of appropriately acquiring depth information of an image in which a plurality of virtual objects including a translucent material are drawn.

An aspect of the invention is an information processing device including one or more processors and/or circuitry configured to: execute rendering processing of 1) acquiring first depth information, which is depth information of a first image in which a plurality of virtual objects including a translucent material are disposed, and 2) generating the first image on a basis of the first depth information; execute acquisition processing of acquiring second depth information indicating a depth of the translucent material in the first image; and execute correction processing of correcting the first depth information on a basis of the second depth information.

An aspect of the invention is an information processing method, including: executing rendering processing of 1) acquiring first depth information, which is depth information of a first image in which a plurality of virtual objects including a translucent material are disposed, and 2) generating the first image on a basis of the first depth information; executing acquisition processing of acquiring second depth information indicating a depth of the translucent material in the first image; and executing, on a basis of the second depth information, correction processing of correcting the first depth information.

Further features of the present invention will become apparent from the following description of exemplary embodiments with reference to the attached drawings.

### BRIEF DESCRIPTION OF THE DRAWINGS

FIG. 1 is a hardware configuration diagram of a correction system according to Embodiment 1;

FIG. 2 is a functional block diagram of the correction system according to Embodiment 1;

FIG. 3 is a flowchart of processing of a depth-acquiring unit according to Embodiment 1;

FIG. 4 is a flowchart of processing of a depth-correcting unit according to Embodiment 1;

FIG. 5 is an internal configuration diagram of an image-processing unit according to Embodiment 1;

FIG. 6 is a functional block diagram of the correction system according to Embodiment 2;

FIG. 7 is an internal configuration diagram of a depth-correcting unit according to Embodiment 2; and

FIG. 8 is a flowchart of a processing of a depth-selecting unit according to Embodiment 2.

### DESCRIPTION OF THE EMBODIMENTS

Hereinafter, embodiments will be explained in detail with reference to attached drawings.

### Embodiment 1

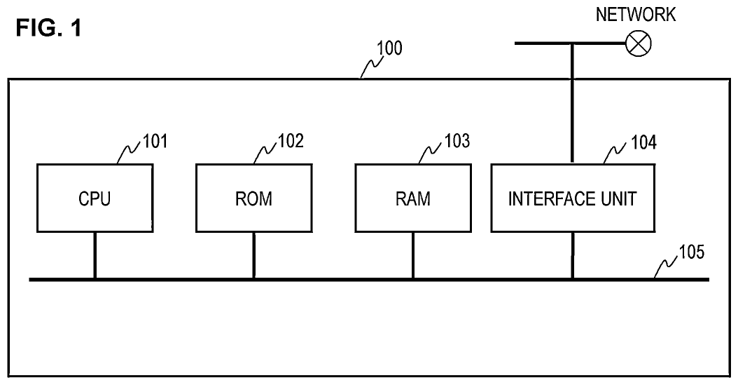

FIG. 1 is a hardware configuration diagram of a correction system 100. The correction system 100 is an information processing device of a computer, a smartphone, a head mount display (HMD), a digital camera (image pickup device) or other home appliances and the like. The correction system 100 has a CPU (Central Processing Unit) 101, a ROM (Read Only Memory) 102, a RAM (Random Access Memory) 103, and an interface unit 104. Each of the configurations is connected by a bus 105.

The CPU 101 controls the entire correction system 100 in accordance with a program stored in the ROM 102 or a program loaded to the RAM 103.

The ROM 102 is a read-only memory. The ROM 102 stores a boot program, a firmware, various types of processing programs, and various types of data.

The RAM 103 is a work memory which temporarily stores a program and data so that the CPU 101 executes processing. To the RAM 103, various types of processing programs and data are loaded by the CPU 101.

The interface unit 104 is an interface for communicating with an external device via a network. The interface unit 104 performs transmission/reception of data via the network.

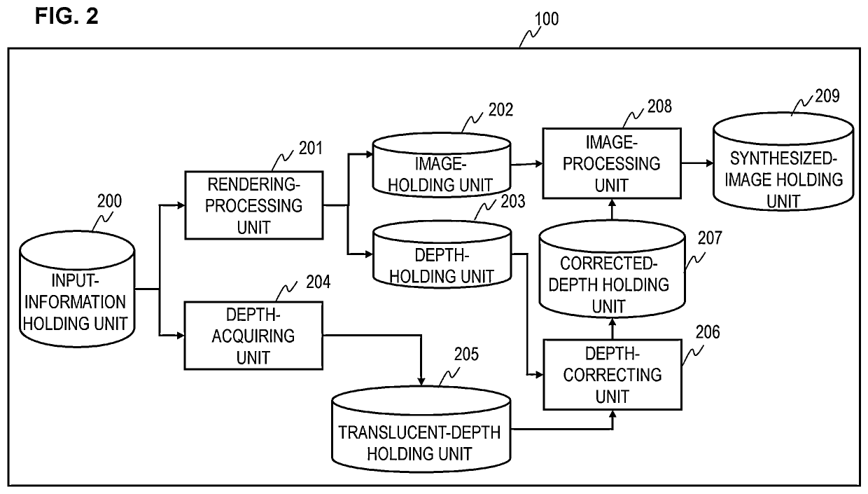

FIG. 2 is a functional block diagram of the correction system 100 in Embodiment 1. In Embodiment 1, the correction system 100 is assumed to be a display system (HMD system) which expresses a virtual reality space or an expanded reality space but may be a system other than that. The correction system 100 has an input-information holding unit 200, a rendering-processing unit 201, an image-holding unit 202, a depth-holding unit 203, a depth-acquiring unit 204, a translucent-depth holding unit 205, a depth-correcting unit 206, a corrected-depth holding unit 207, an image-processing unit 208, and a synthesized-image holding unit 209.

The input-information holding unit 200 holds input information required for rendering a plurality of virtual objects (CG) including a translucent material (virtual object having permeability). The input information is model data of the virtual object, positional information of the virtual object, information of a viewpoint when a virtual object is to be drawn (information such as a position, a field angle, a resolution and the like) and the like.

The rendering-processing unit 201 executes the rendering processing on the basis of the input information acquired from the input-information holding unit 200. Specifically, first, the rendering-processing unit 201 acquires (generates) depth information of a CG image, which is an image in which a plurality of virtual objects including a translucent material (a virtual object having permeability) are disposed, on the basis of the input information. After acquisition (generation) of the depth information, the rendering-processing unit 201 generates the CG image on the basis of the input information and the depth information. The depth information is an image in which each pixel indicates a depth to a subject. Moreover, the depth information of the CG image is information indicating a depth of each pixel (each position) of the CG image.

Here, for higher efficiency of the generation of CG images, the rendering-processing unit 201 generates, in each pixel, a CG image so that only the virtual object at a position of the depth indicated by the depth information and the virtual object positioned on the front surface of the depth are drawn. Thus, since the virtual object, which is present at a position deeper than the translucent material, also needs to be drawn on the CG image, the depth of the virtual object needs to be indicated by the depth information. Thus, the rendering-processing unit 201 acquires the depth information by ignoring the presence of the translucent material.

The image-holding unit 202 holds the CG image (two-dimensional image) generated by the rendering-processing unit 201.

The depth-holding unit 203 holds the depth information of the CG image acquired by the rendering-processing unit 201 (hereinafter, called “CG-depth information”).

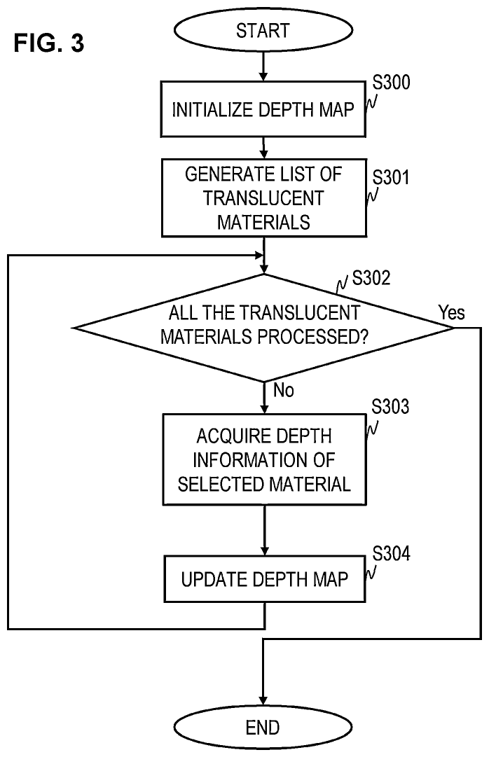

The depth-acquiring unit 204 acquires the depth information only of the translucent material in the CG image (hereinafter, called “translucent-depth information”) in the plurality of virtual objects drawn in the CG image on the basis of the input information. For example, the depth-acquiring unit 204 acquires the translucent-depth information by executing rendering by handling the translucent material as a non-transparent material on the basis of the input information. Details of processing of the depth-acquiring unit 204 will be described later by referring to a flowchart in FIG. 3.

The translucent-depth holding unit 205 holds the translucent-depth information.

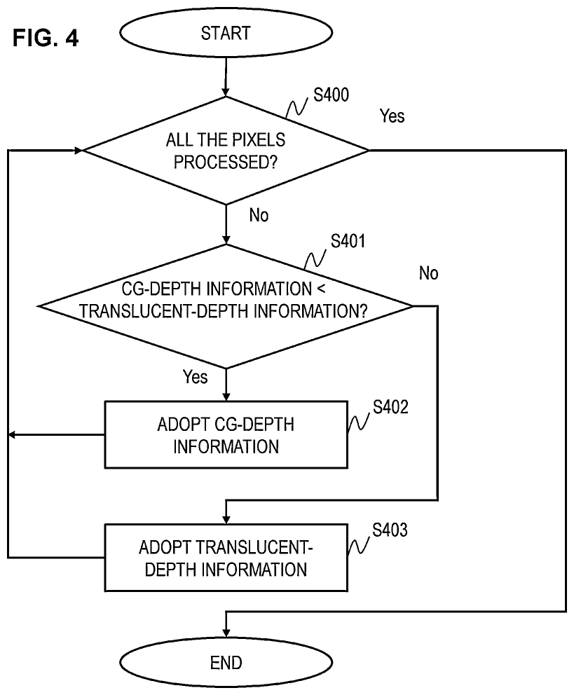

The depth-correcting unit 206 corrects the CG-depth information on the basis of the translucent-depth information. Details of processing of the depth-correcting unit 206 will be described later by referring to a flowchart in FIG. 4.

The corrected-depth holding unit 207 holds the CG-depth information corrected by the depth-correcting unit 206 (hereinafter called “corrected information”).

The image-processing unit 208 synthesizes a specific image (a photographed image taken by an image pickup device that picked up an image of a real space, for example) and the CG image on the basis of the corrected information. As a result, the image-processing unit 208 generates a synthesized image. The image-processing unit 208 may execute arbitrary processing on the basis of the corrected information, as long as it is processing related to the CG image. For example, the image-processing unit 208 may estimate a position of each of the virtual objects of a subsequent frame on the basis of the corrected information and a degree of movement of the head part of the user and correct a CG image on the basis of the estimation result. Alternatively, the image-processing unit 208 may generate an image in which each pixel of a CG image is colored in a color corresponding to a size of the depth indicated by the depth information.

The synthesized-image holding unit 209 holds a synthesized image generated by the image-processing unit 208.

By referring to a flowchart in FIG. 3, details of the processing of the depth-acquiring unit 204 will be explained.

At Step S300, the depth-acquiring unit 204 initializes a depth map, which is depth information indicating depths of all the translucent materials in the CG image. Specifically, the depth-acquiring unit 204 sets a value corresponding to infinity to each of all the pixels of the depth map.

At Step S301, the depth-acquiring unit 204 generates a list of the translucent materials indicating one or a plurality of translucent materials for which the rendering was executed on the basis of the input information held by the input-information holding unit 200.

At Step S302, the depth-acquiring unit 204 selects one translucent material in the list of the translucent materials generated at Step S301. The depth-acquiring unit 204 executes processing at Step S303 and after in relation with the selected translucent material (hereinafter, called a “selected material). When the processing at Step S303 and after is executed in relation with all the translucent materials in the list of the translucent materials, the processing of this flowchart is finished. Then, the depth-acquiring unit 204 handles the depth map as the translucent-depth information.

At Step S303, the depth-acquiring unit 204 acquires the depth information of the selected material on the basis of the input information. The depth-acquiring unit 204 acquires the depth information only of the pixels drawn on the CG image in the selected material. The depth-acquiring unit 204 does not acquire the depth information of the pixel not drawn on the CG image.

At Step S304, the depth-acquiring unit 204 compares the “depth indicated by the depth information of the selected material acquired at Step S303” and the “depth indicated by the depth map” at the same pixel coordinates for each pixel of the selected material in the CG image. Regarding each pixel coordinate, if the “depth indicated by the depth information of the selected material” is smaller (the distance is shorter) than the “depth indicated by the depth map”, the depth-acquiring unit 204 updates the “depth indicated by the depth map” to the “depth indicated by the depth information of the selected material.”.

By referring to a flowchart in FIG. 4, details of the processing by the depth-correcting unit 206 will be explained.

At Step S400, the depth-correcting unit 206 determines whether or not the processing at Step S401 and after has been executed for all the pixels of the translucent-depth information. Note that, in the CG-depth information and the translucent-depth information, screen resolutions (aspect ratio and the number of pixels) match each other. If it is determined that the processing at Step S401 and after has been executed for all the pixels of the translucent-depth information, the processing of this flowchart is finished. If it is determined that the processing at Step S401 and after has not been executed for at least one pixel of the translucent-depth information, the processing of the processing at Step S401 and after is executed for the one pixel for which the processing at Step S401 and after has not been executed. Hereinafter, the pixel to be processed at Step S401 and after (pixel of the translucent-depth information) shall be called a “selected pixel”.

At Step S401, the depth-correcting unit 206 determines whether or not the “depth indicated by the pixel of the CG-depth information at the coordinates of the selected pixel (hereinafter, called a “CG depth”)” is less than the “depth indicated by the selected pixel of the translucent-depth information (hereinafter, called the “selected depth”)”. If it is determined that the CG depth is less than the selected depth, the processing proceeds to Step S402. If it is determined that the CG depth is equal to or larger than the selected depth, the processing proceeds to Step S403.

At Step S402, the depth-correcting unit 206 adopts the CG depth as a depth of the corrected information at the coordinates of the selected pixel. At Step S403, the depth-correcting unit 206 adopts the selected depth as a depth of the corrected information at the coordinates of the selected pixel.

That is, at Steps S401 to S403, the depth-correcting unit 206 adopts a smaller one (indicating the front) of the CG depth and the selected depth as the depth of the corrected information at the coordinates of the selected pixel.

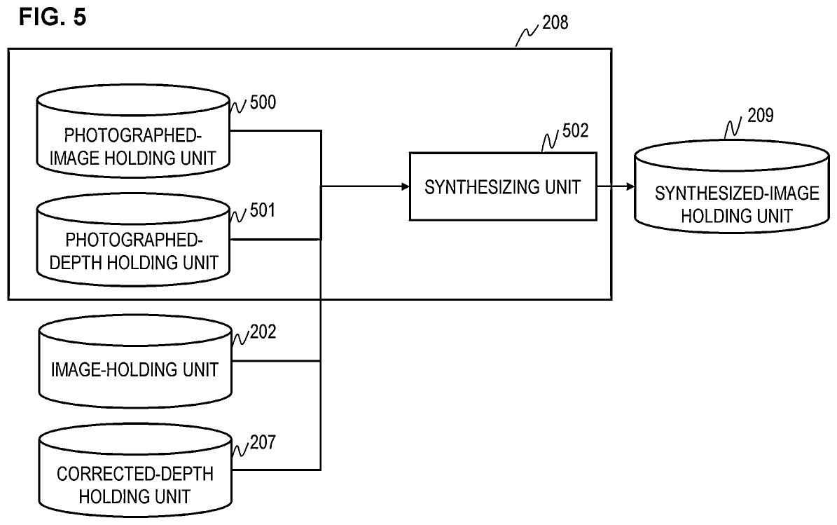

FIG. 5 is a diagram for explaining a specific processing example of the image-processing unit 208. The image-processing unit 208 has a photographed-image holding unit 500, a photographed-depth holding unit 501, and a synthesizing unit 502.

The photographed-image holding unit 500 holds an image acquired by the image pickup device (image pickup device mounted on a front of an HMD or the like) by picking up an image of a real space (hereinafter, called a “photographed image”).

The photographed-depth holding unit 501 holds depth information of a photographed image. The depth information of the photographed image can be acquired by a measured value of a distance sensor, a stereo matching using a plurality of images picked up from a plurality of viewpoints or the like.

The synthesizing unit 502 generates a synthesized image by synthesizing a photographed image and a CG image (image in which a plurality of virtual objects including a translucent material are disposed). The synthesizing unit 502 compares the “depth indicated by the depth information of the photographed image” and the “depth indicated by the corrected-depth information” for each pixel. The synthesizing unit 502 adopts, in the synthesized image, a pixel value of the photographed image for a pixel whose “depth indicated by the depth information of the photographed image” is smaller. The synthesizing unit 502 adopts, in the synthesized image, a pixel value of the CG image for a pixel whose “depth indicated by the corrected depth information” is smaller. As described above, the synthesizing unit 502 synthesizes the photographed image and the CG image by considering an appropriate depth.

As described above, in Embodiment 1, the correction system 100 acquires the depth information of the translucent material by processing, which is different from the normal rendering processing. And the correction system 100 corrects the depth information of the CG image acquired by the normal rendering processing on the basis of the depth information of the translucent material. As a result, the depth information of the CG image considering the translucent material can be acquired. As a result, quality deterioration of image processing can be prevented.

### Embodiment 2

In Embodiment 1, the correction system 100 acquires the depth information of the translucent material by the processing, which is different from the normal rendering processing, and corrects the depth information acquired in the normal rendering processing. As a result, the correction system 100 can acquire the depth information considering the translucent material. However, in Embodiment 1, the correction system 100 needs to refer to the input information (model data of virtual objects, positional information of the virtual objects, information on viewpoints when the virtual objects are drawn and the like) in order to acquire the depth information of the translucent material.

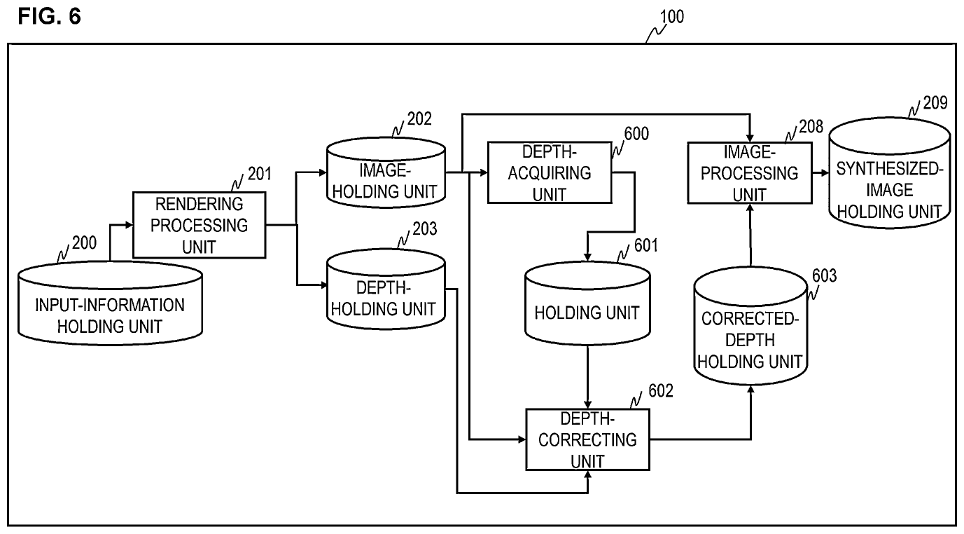

In Embodiment 2, the correction system 100 acquires the depth information of the translucent material without referring to the input information. FIG. 6 is a functional block diagram illustrating a configuration example of the correction system 100 in Embodiment 2. The correction system 100 has the input-information holding unit 200, the rendering-processing unit 201, the image-holding unit 202, the depth-holding unit 203, the image-processing unit 208, the synthesized-image holding unit 209, a depth-acquiring unit 600, a holding unit 601, a depth-correcting unit 602, and a corrected-depth holding unit 603.

The depth-acquiring unit 600 acquires the depth information of the CG image on the basis of the CG image generated by the rendering-processing unit 201. Specifically, the depth-acquiring unit 600 acquires the depth information of the CG image by stereo matching processing using a plurality of CG images of the virtual object viewed from a plurality of different viewpoints (CG images of the virtual object viewed from a left-eye viewpoint and a right-eye viewpoint, for example), for example. The depth-acquiring unit 600 may acquire the depth information of a CG image on the basis of the CG image by using a deep learning model (deep learning information) learned in advance. For example, the depth-acquiring unit 600 executes depth estimation processing on the basis of a single image using Deep Learning.

Hereinafter, the depth information acquired on the basis of the CG image shall be called “base information”. Since the base information is acquired on the basis of the CG image in which the translucent material is drawn, information on the depth of the translucent material is included. However, accuracy (correctness) of the depth of the virtual object other than the translucent material is higher in the CG-depth information acquired on the basis of the input information than in the base information.

The holding unit 601 holds the base information acquired by the depth-acquiring unit 600.

The depth-correcting unit 602 acquires corrected information by correcting the CG-depth information on the basis of the CG image and the base information.

The corrected-depth holding unit 603 holds the corrected information.

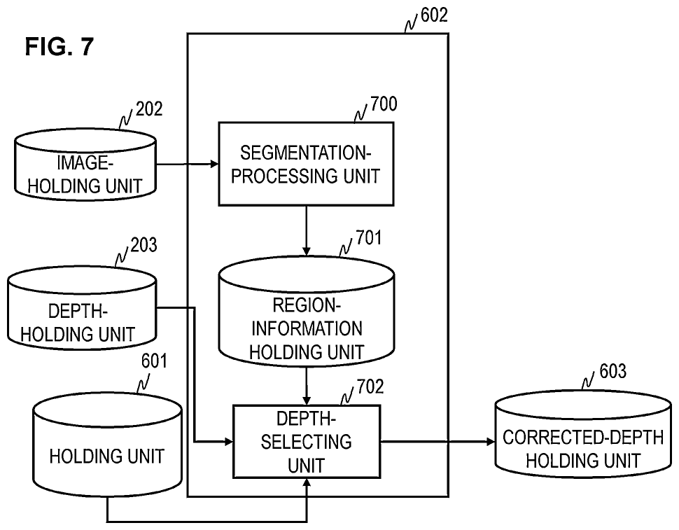

FIG. 7 is a functional block diagram for explaining processing of the depth-correcting unit 602. The depth-correcting unit 602 has a segmentation-processing unit 700, a region-information holding unit 701, and a depth-selecting unit 702.

The segmentation-processing unit 700 executes image segmentation processing on the CG image. As a result, the segmentation-processing unit 700 divides the CG image on which a plurality of the virtual objects are drawn into regions for each virtual object (object). And the segmentation-processing unit 700 labels each of the divided regions.

The region-information holding unit 701 individually holds information on each region labeled by the segmentation-processing unit 700 (hereinafter, called a “mask region”).

The depth-selecting unit 702 generates the corrected information on the basis of the CG-depth information and the base information.

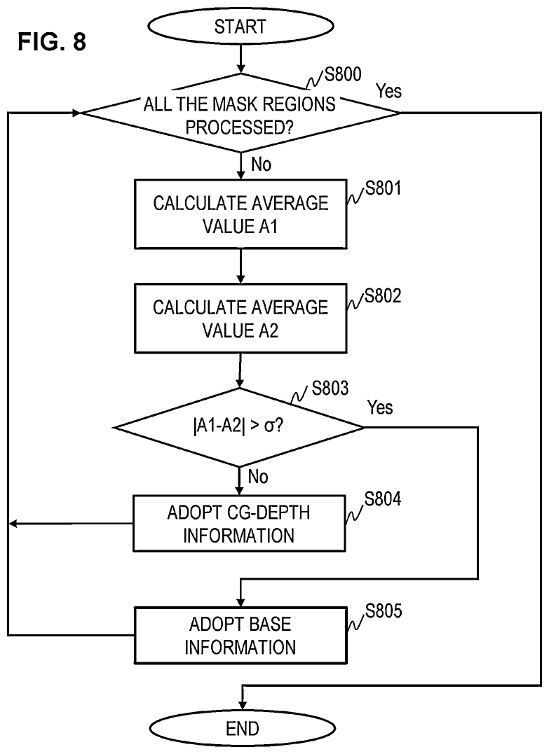

By referring to a flowchart in FIG. 8, processing of the depth-selecting unit 702 in Embodiment 2 will be explained. The processing of the depth-selecting unit 702 is not limited to the processing in the flowchart in FIG. 8, but an arbitrary processing may be adopted.

At Step S800, the depth-selecting unit 702 determines whether or not processing at Step S801 and after has already been executed on all the mask regions held by the region-information holding unit 701. If it is determined that the processing at Step S801 and after has already been executed on all the mask regions, the processing of this flowchart is finished. If it is determined that the processing at Step S801 and after has not been executed at least on one of all the mask regions, the depth-selecting unit 702 selects one mask region in one or a plurality of mask regions on which it was determined that the processing at Step S801 and after has not been executed. Here, the mask region selected by the depth-selecting unit 702 shall be called a selected region. After that, the processing proceeds to Step S801.

At Step S801, the depth-selecting unit 702 calculates an average value A1 of the depth indicated by the CG-depth information in the selected region. At Step S802, the depth-selecting unit 702 calculates an average value A2 of the depth indicated by the base information in the selected region.

Note that the “average value of the depth” at Steps S801 and S802 may be an arbitrary value, as long as it is a value indicating a depth of the selected region such as a “median value of the depth” or the “total of the depths”.

At Step S803, the depth-selecting unit 702 determines whether or not an absolute value A3 of a difference between the average value A1 and the average value A2 is larger than a threshold value σ. If it is determined that the absolute value A3 is equal to or smaller than the threshold value σ, the processing proceeds to Step S804. If it is determined that the absolute value A3 is larger than the threshold value σ, the processing proceeds to Step S805. The threshold value σ may be a fixed value (1000 mm, for example) or may be changeable by the image-processing unit 208.

At Step S804, the depth-selecting unit 702 substitutes (adopts) the depth of the selected region in the CG-depth information for the depth of the selected region in the corrected information.

At Step S805, the depth-selecting unit 702 substitutes (adopts) the depth of the selected region in the base information for the depth of the selected region in the corrected information. Here, at Step S803, if it is determined that the absolute value A3 is larger than the threshold value σ, it is highly likely that the selected region is a region of the translucent material. Thus, at Step S805, the depth-selecting unit 702 adopts the depth of the selected region in the base information including the depth of the translucent material.

As described above, the correction system 100 corrects the CG-depth information on the basis of the CG image. As a result, the depth information considering the depth of the translucent material can be acquired.

According to the present invention, the depth information of an image in which a plurality of virtual objects including a translucent material are drawn can be appropriately acquired.

As described above, the present invention has been described in detail on the basis of the embodiments thereof, but the present invention is not limited to these specific embodiments, but various forms within a range not departing from the gist of this invention are also included in the present invention. A part of the aforementioned embodiment may be combined as appropriate.

Moreover, in the above, “if A is equal to or larger than B, the processing proceeds to Step S1, while if A is smaller (lower) than B, the processing proceeds to Step S2” may read such that “if A is larger (higher) than B, the processing proceeds to Step S1, while if A is equal to or smaller than B, the processing proceeds to Step S2”. To the contrary, “if A is larger (higher) than B, the processing proceeds to Step S1, while if A is equal to or smaller than B, the processing proceeds to Step S2” may read such that “if A is equal to or larger than B, the processing proceeds to Step S1, while if A is smaller (lower) than B, the processing proceeds to Step S2”. Thus, as long as there is no contradiction, “equal to or larger than A” may read “larger (higher; longer; more) than A”, and “equal to or smaller than A” may read “smaller (lower; shorter; less) than A”. And “larger (higher; longer; more) than A” may read “equal to or larger than A”, and “smaller (lower; shorter; less) than A” may read “equal to or smaller than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-192821, filed on Nov. 13, 2023, which is hereby incorporated by reference herein in its entirety.

What is claimed is:

1. An information processing device comprising one or more processors and/or circuitry configured to:
execute rendering processing of 1) acquiring first depth information, which is depth information of a first image in which a plurality of virtual objects including a translucent material are disposed, and 2) generating the first image on a basis of the first depth information;
execute acquisition processing of acquiring second depth information indicating a depth of the translucent material in the first image; and
execute correction processing of correcting the first depth information on a basis of the second depth information.

2. The information processing device according to claim 1, wherein
in the rendering processing, the first depth information is acquired by ignoring presence of the translucent material in the plurality of virtual objects.

3. The information processing device according to claim 1, wherein
each of the first depth information and the second depth information is information indicating depths of a plurality of positions of the first image; and
in the correction processing, for each of the plurality of positions of the first image, smaller one of a depth indicated by the first depth information and a depth indicated by the second depth information is adopted as a depth indicated by the corrected first depth information.

4. The information processing device according to claim 1, wherein
each of the first depth information and the second depth information is information indicating depths of the plurality of virtual objects in the first image; and
in the correction processing, for each of the plurality of virtual objects, in a case where a difference between a depth indicated by the first depth information and a depth indicated by the second depth information is larger than a threshold value, the depth indicated by the second depth information is adopted as a depth indicated by the corrected first depth information.

5. The information processing device according to claim 1, wherein
in the acquisition processing, the second depth information is acquired on a basis of the first image generated by the rendering processing.

6. The information processing device according to claim 1, wherein
in the acquisition processing, the second depth information is acquired on a basis of a plurality of images viewing the plurality of virtual objects from a plurality of different viewpoints.

7. The information processing device according to claim 1, wherein
in the acquisition processing, the second depth information is acquired by using a deep learning model learned in advance.

8. The information processing device according to claim 1, wherein
on a basis of the first depth information corrected in the correction processing, related processing, which is processing related to the first image, is executed.

9. The information processing device according to claim 8, wherein
in the related processing, the first image and the second image are synthesized on a basis of the first depth information.

10. An information processing method, comprising:
executing rendering processing of 1) acquiring first depth information, which is depth information of a first image in which a plurality of virtual objects including a translucent material are disposed, and 2) generating the first image on a basis of the first depth information;
executing acquisition processing of acquiring second depth information indicating a depth of the translucent material in the first image; and
executing, on a basis of the second depth information, correction processing of correcting the first depth information.

11. A non-transitory computer readable medium that stores a program, wherein the program causes a computer to execute an information processing method,
the information processing method comprising:
executing rendering processing of 1) acquiring first depth information, which is depth information of a first image in which a plurality of virtual objects including a translucent material are disposed, and 2) generating the first image on a basis of the first depth information;
executing acquisition processing of acquiring second depth information indicating a depth of the translucent material in the first image; and
executing, on a basis of the second depth information, correction processing of correcting the first depth information.
